(19) United States
(12) Patent Application Publication
(10) Pub. No.: US 2026/0008510 A1
(43) Pub. Date: Jan. 8, 2026

(54) Bike Saddle

(71) Applicant: Foshan AIFEIT Bicycle Accessory Co., Ltd., Foshan (CN)

(72) Inventor: Dongbi Liu, Foshan (CN)

(73) Assignee: Foshan AIFEIT Bicycle Accessory Co., Ltd., Foshan (CN)

(21) Appl. No.: 19/305,645

(22) Filed: Aug. 20, 2025

(30) Foreign Application Priority Data
Nov. 14, 2024 (CN) 202411623758.0

(51) Int. Cl. B62J 1/02; B62J 1/00; B62J 1/26

(52) U.S. Cl. CPC B62J 1/02; B62J 1/002; B62J 1/26

(57) ABSTRACT

The present disclosure relates to the technical field of bicycles and discloses a bike saddle, which comprises a base. The base is provided with an elongate hole that serves a ventilating function. A first plastic case and a second plastic case are symmetrically arranged on the top surface of the base. The first plastic case and the second plastic case are provided with a first foam sleeve and a second foam sleeve respectively for increasing the contact area. The area formed by the first foam sleeve and the second foam sleeve in this disclosure is significantly larger, far exceeding that in the prior art, thereby increasing the contact area between the user and the saddle. Even after prolonged use, this reduces the likelihood of the user experiencing soreness.

### CROSS-REFERENCE TO RELATED APPLICATIONS

The present application claims priority to Chinese Patent Application No. 202411623758.0, filed on Nov. 14, 2024, the content of which is incorporated herein by reference in its entirety.

### TECHNICAL FIELD

The present disclosure relates to the technical field of bicycles, particularly to a bike saddle.

### BACKGROUND

Bicycles are a common means of transportation. Compared to cars and electric vehicles, they offer energy-saving and fitness benefits, which is why many people remain passionate about cycling. The bike saddle is a crucial component of a bicycle, as it directly contacts the rider's buttocks during cycling. It consists of four parts and can be divided into two types: narrow, elongated hard saddles, commonly found on sports bikes and designed for high-speed cruising, and wide, soft comfort saddles, typically seen on entry-level or leisure-oriented bikes, designed for slow-speed cruising.

Chinese patent CN109515568A discloses a bike saddle and belongs to the technical field of bikes. The bike saddle comprises a saddle cover, an elastic cushion and a saddle-shaped bottom case connected with a bile. The saddle-shaped bottom case is sleeved with the saddle cover. The elastic cushion is arranged between the saddle-shaped bottom case and the saddle cover. The elastic cushion is provided with a reinforcement structure. Through the structure, the bike saddle provided by the invention has good comfortability and also has a certain strength and stiffness to deal with large acting force, so that the elastic cushion is protected against irreversible deformation or skewing towards one side when bearing large acting force generated from alternating motion of the hip and crotch of a user. Thus, the whole bike saddle has higher stability to ensure the safety of the user and is suitable for bike sports events. However, in the prior art, the contact area between the bike saddle and the user is relatively small, often causing discomfort after prolonged riding. Additionally, heat dissipation is inadequate, necessitating further improvements.

Therefore, based on the above technical issues, there is a need for professionals in the field to develop a new bike saddle.

### SUMMARY

An object of the present disclosure is to provide a bike saddle to address the issues raised in the background art.

To achieve this object, the present disclosure provides the following technical solutions:

In a technical solution of a bike saddle, the bike saddle comprises a base. The base is provided with an elongate hole that serves a ventilating function. A first plastic case and a second plastic case are symmetrically arranged on the top surface of the base, and the first plastic case and the second plastic case are provided with a first foam sleeve and a second foam sleeve respectively for increasing the contact area.

As a preferred technical solution, the base comprises a first shell and a second shell, and each of the first shell and the second shell is provided with a cavity. The first shell and the second shell are fixedly connected by a first connecting block, and a second connecting block, parallel to the first connecting block, is installed between the first shell and the second shell. The first shell, the second shell and the first connecting block are integrally formed, and the first shell, the second shell, and the second connecting block are integrally formed.

As a preferred technical solution, the top surfaces of the first shell and the second shell are provided with a first through hole and a second through hole, the bottom surfaces of the first plastic case and the second plastic case are both provided with a first threaded hole and a second threaded hole corresponding to the first through hole and the second through hole, and a first bolt and a second bolt, threadedly connected to the first threaded hole and the second threaded hole, are inserted through the first through hole and the second through hole.

As a preferred technical solution, the bottom surfaces of the first shell and the second shell are both provided with third through holes, the first plastic case and the second plastic case are both provided with third threaded holes corresponding to the third through holes, and third bolts, threadedly connected to the third threaded holes, are inserted through the third through holes.

As a preferred technical solution, the first shell and the second shell are both provided with placement slots, the two placement slots are both provided with limit posts, and the two limit posts are integrally formed with the first shell and the second shell respectively.

As a preferred technical solution, the first shell, the second shell and the first connecting block are all symmetrically provided with two first reinforcing ribs, and the two first reinforcing ribs, the first shell, the second shell and the first connecting block are integrally formed.

As a preferred technical solution, both ends of each of the two first reinforcing ribs are integrally formed with cylindrical sleeves, the two cylindrical sleeves are integrally formed with the first shell and the second shell respectively, and the two cylindrical sleeves are both provided with guide assemblies.

As a preferred technical solution, each of the guide assembly comprises a guide rod installed in the cylindrical sleeve, and the guide rod is provided with a first damping sleeve. The top end of the first damping sleeve is arranged inside the cylindrical sleeve, and the bottom end of the guide rod is provided with a second damping sleeve detachably fixed to the first damping sleeve.

As a preferred technical solution, two rectangular grooves are symmetrically arranged on a periphery of the second damping sleeve, and engaging blocks are arranged in the two rectangular grooves.

Compared with the prior art, the beneficial effects of the present disclosure are as follows:

(1) The area formed by the first foam sleeve and the second foam sleeve is relatively large and significantly greater than that in the prior art, increasing the contact area between the user and the seat cushion. Even after prolonged use, it reduces the likelihood of the user experiencing soreness.

(2) Both the first foam sleeve and the second foam sleeve are made of foamed materials, making them softer and further enhancing user comfort.

(3) The elongate hole is designed to allow air to escape when the saddle is in use, improving breathability and reducing excessive sweating between the user and the saddle, thereby increasing the comfort level of the user.

### BRIEF DESCRIPTION OF DRAWINGS

FIG. 1 is a schematic diagram of the overall structure of a bike saddle.

FIG. 2 is a schematic diagram showing the positional relationship between the first plastic case, the second plastic case, the first shell, and the second shell in a bike saddle.

FIG. 3 is a schematic diagram of the first shell and second shell of a bike saddle from one angle.

FIG. 4 is a schematic diagram of the first shell and second shell of a bike saddle from another angle.

FIG. 5 is a schematic diagram of the second damping sleeve in a bike saddle.

Refence signs: 1, First shell; 2, Second shell; 3, Elongate hole; 4, First plastic case; 5, Second plastic case; 6, First foam sleeve; 7, Second foam sleeve; 8, First connecting block; 9, Second connecting block; 10, First through hole; 11, Second through hole; 15, Third through hole; 16, Placement slot; 17, Limit post; 18, First reinforcing rib; 19, Cylindrical sleeve; 20, Guide rod; 21, First damping sleeve; 23, Second damping sleeve; 24, Rectangular groove; 25, Engaging block.

### DESCRIPTION OF EMBODIMENTS

The features and exemplary embodiments of the present disclosure will be described in detail below. To make the objectives, technical solutions, and advantages of the present disclosure clearer, the description below is further elaborated with reference to the drawings and specific examples. For those skilled in the art, the present disclosure can be implemented without some of these specific details. The description of the embodiments is merely intended to provide a better understanding of the present disclosure by illustrating examples thereof.

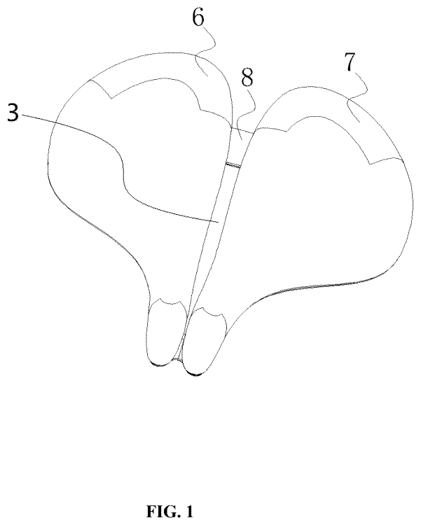

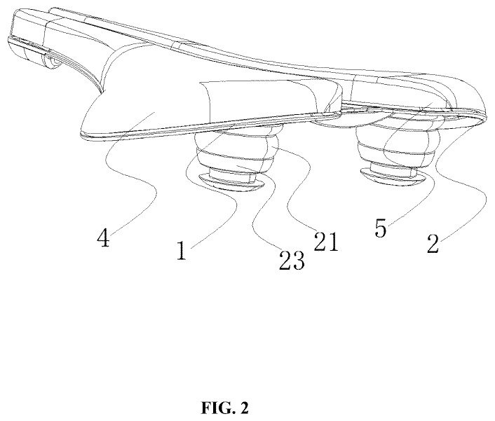

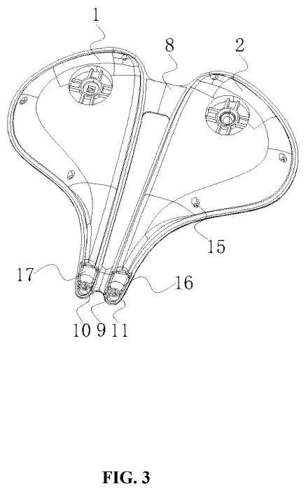

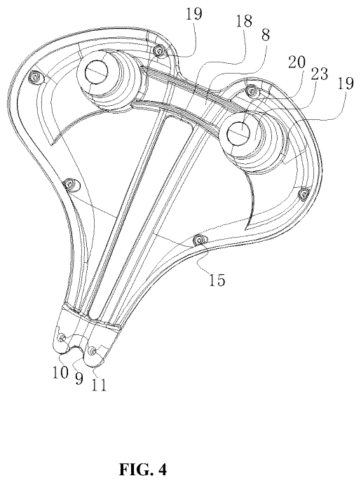

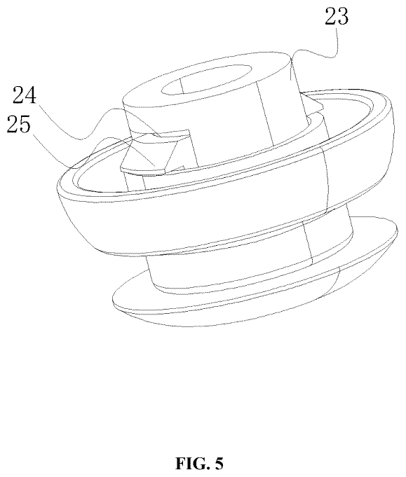

As shown in FIGS. 1-5, the present disclosure provides a technical solution for a bike saddle: it includes a base, which consists of a first shell 1 and a second shell 2. The first shell 1 and the second shell 2 share the same shape and material, and each is equipped with a cavity. The first shell 1 and the second shell 2 are fixedly connected by a first connecting block 8, in which case the first shell 1 and the second shell 2 are arranged symmetrically. To further enhance the connection strength between the first shell 1 and the second shell 2, a second connecting block 9, parallel to the first connecting block 8, is installed between the first shell 1 and the second shell 2. The first shell 1, second shell 2, and first connecting block 8 are integrally formed, and the first shell 1, second shell 2, and second connecting block 9 are integrally formed.

In this embodiment, both the first shell 1 and the second shell 2 are equipped with a first plastic case 4 and a second plastic case 5, which are symmetrically arranged. At the same time, the first plastic case 4 and the second plastic case 5 are provided with a first foam sleeve 6 and a second foam sleeve 7, respectively, which are also symmetrically arranged. The user sits directly on the first foam sleeve 6 and the second foam sleeve 7. On one hand, the area formed by the first foam sleeve 6 and the second foam sleeve 7 is relatively large, far exceeding that of the prior art, increasing the contact area between the user and the cushion. Even after prolonged use, this reduces the likelihood of the user experiencing soreness. Moreover, both the first foam sleeve 6 and the second foam sleeve 7 are made of foamed materials, making them softer and further enhancing the user's comfort.

In this embodiment, an elongate hole 3 is reserved between the first foam sleeve 6 and the second foam sleeve 7. When the cushion is used, gas can escape through the elongate hole 3, improving the cushion's breathability. This reduces excessive sweating between the user and the cushion, thereby enhancing the user's comfort.

In this embodiment, the top surface of the first shell 1 and the second shell 2 is provided with a first through hole 10 and a second through hole 11, which are symmetrically arranged. Meanwhile, the bottom surfaces of the first plastic case 4 and the second plastic case 5 are each provided with a first threaded hole and a second threaded hole corresponding to the first through hole 10 and the second through hole 11, respectively. A first bolt and a second bolt, threaded into the first threaded hole and the second threaded hole, are inserted through the first through hole 10 and the second through hole 11. The first bolt and the second bolt are symmetrically arranged, securing the first shell 1 to the first plastic case 4 and the second shell 2 to the second plastic case 5. Additionally, if either the first shell 1 or the second shell 2 is damaged, the user only needs to unscrew the first bolt and the second bolt, making it convenient to replace the first plastic case 4 and the second plastic 5.

To further enhance the connection strength between the first shell 1 and the first plastic case 4, as well as between the first shell 1 and the second plastic case 5, multiple third through holes 15 are arranged on the bottom surfaces of both the first shell 1 and the second shell 2. These third through holes 15 are arranged along the curved direction of the first shell 1. Simultaneously, third threaded holes corresponding to the third through holes 15 are arranged on both the first plastic case 4 and the second plastic case 5. Third bolts, threaded into the third threaded holes, are inserted through the third through holes 15. The third bolts, along with the first bolt and the second bolt, work synergistically to increase the connection strength between the first shell 1 and the first plastic case 4, as well as between the second shell 2 and the second plastic case 5.

In this embodiment, placement slots 16 are opened on both the first shell 1 and the second shell 2. Limit posts 17 are installed in both placement slots 16, and these limit posts 17 are integrally formed with the first shell 1 and the second shell 2, respectively. After the first plastic case 4 and the second plastic case 5 are mounted onto the first shell 1 and the second shell 2, the two limit posts 17 serve to restrict the movement of the first plastic case 4 and the second plastic case 5, reducing the likelihood of spontaneous displacement between the first shell 1 and the first plastic case 4, as well as between the second shell 2 and the second plastic case 5.

In this embodiment, two first reinforcing ribs 18 are symmetrically arranged on the first shell 1, the second shell 2, and the first connecting block 8. The two first reinforcing ribs 18, along with the first shell 1, the second shell 2, and the first connecting block 8, are integrally formed. The two first reinforcing ribs 18 and the first connecting block 8 work synergistically to further improve the connection strength between the first shell 1 and the second shell 2.

In this embodiment, cylindrical sleeves 19 are integrally formed at both ends of the two first reinforcing ribs 18. The two cylindrical sleeves 19 are parallel to each other and are integrally formed with the first shell 1 and the second shell 2, respectively. Guide assemblies are installed inside both cylindrical sleeves 19, serving a limiting function and reducing the likelihood of the seat cushion dropping when subjected to additional pressure.

There are two sets of guide assemblies. Taking one set as an example, the guide assembly includes a guide rod 20, which is installed inside the cylindrical sleeve 19 and positioned at the center of the cylindrical sleeve 19. A first damping sleeve 21 is mounted on the guide rod 20. The first damping sleeve 21 is elastic, and its top end is placed inside the cylindrical sleeve 19, and the cylindrical sleeve 19 can limit the movement of the first damping sleeve 21. Additionally, a second damping sleeve 23, which is detachably fixed to the first damping sleeve 21, is inserted through the guide rod 20. The first damping sleeve 21 is elastic, and the second damping sleeve 23 cooperates with the first damping sleeve 21 to collectively enhance damping efficiency.

In this embodiment, two rectangular grooves 24 are symmetrically arranged on the periphery of the second damping sleeve 23. Engaging blocks 25 are placed inside these two rectangular grooves 24. The engaging blocks 25 themselves are elastic. After the second damping sleeve 23 is inserted into the first damping sleeve 21, the two engaging blocks 25 return to their original shape, securing the first damping sleeve 21 and the second damping sleeve 23 together. When either the first damping sleeve 21 or the second damping sleeve 23 is damaged, it facilitates replacement by the user.

The above descriptions represent only the preferred specific embodiments of the present disclosure. However, the scope of protection for the present disclosure is not limited to these. Any technical personnel familiar with the relevant field, within the technical scope disclosed by the present disclosure, may make equivalent replacements or modifications based on the technical solutions and inventive concepts of the present disclosure, all of which should fall within the protection scope of the present disclosure.

In the description of the present disclosure, it should be understood that terms such as “coaxial,” “bottom,” “one end,” “top,” “middle,” “the other end,” “upper,” “one side,” “top,” “inner,” “front,” “center,” and “both ends” refer to orientations or positional relationships based on those shown in the accompanying drawings. These terms are used solely for ease of description and simplification, and do not indicate or imply that the referenced devices or components must have specific orientations or be constructed and operated in specific orientations. Therefore, they should not be construed as limiting the present disclosure.

In the present disclosure, unless otherwise explicitly specified and defined, terms such as “install,” “set,” “connect,” “fix,” and “thread” should be interpreted broadly. For example, connections may be fixed or detachable, or integrated; they may be mechanical or electrical; they may be direct or indirect by an intermediary medium; they may refer to internal communication between two components or their interaction. Unless otherwise explicitly defined, those skilled in the art may interpret the specific meanings of these terms in the present disclosure based on the context.

According to the embodiments of the present disclosure as described above, these embodiments do not exhaustively detail all aspects, nor do they limit the present disclosure to the specific embodiments. Clearly, many modifications and variations can be made based on the above description. These embodiments are selected and described in detail in this specification to better explain the principles and practical applications of the present disclosure, enabling those skilled in the art to utilize the present disclosure effectively and in modifications based on the present disclosure. Any modifications made within the spirit and principles of the present disclosure, equivalent substitutions, improvements, etc., shall fall within the protection scope of the present disclosure.

What is claimed is:

1. A bike saddle, comprising a base, wherein the base is provided with an elongate hole (3) that serves a ventilating function; a first plastic case (4) and a second plastic case (5) are symmetrically arranged on a top surface of the base, and the first plastic case (4) and the second plastic case (5) are provided with a first foam sleeve (6) and a second foam sleeve (7) respectively for increasing a contact area.

2. The bike saddle according to claim 1, wherein the base comprises a first shell (1) and a second shell (2), and each of the first shell (1) and the second shell (2) is provided with a cavity; the first shell (1) and the second shell (2) are fixedly connected by a first connecting block (8), and a second connecting block (9), parallel to the first connecting block (8), is installed between the first shell (1) and the second shell (2); the first shell (1), the second shell (2) and the first connecting block (8) are integrally formed, and the first shell (1), the second shell (2), and the second connecting block (9) are integrally formed.

3. The bike saddle according to claim 2, wherein top surfaces of the first shell (1) and the second shell (2) are provided with a first through hole (10) and a second through hole (11), bottom surfaces of the first plastic case (4) and the second plastic case (5) are both provided with a first threaded hole and a second threaded hole corresponding to the first through hole (10) and the second through hole (11), and a first bolt and a second bolt, threadedly connected to the first threaded hole and the second threaded hole, are inserted through the first through hole (10) and the second through hole (11).

4. The bike saddle according to claim 3, wherein bottom surfaces of the first shell (1) and the second shell (2) are both provided with third through holes (15), the first plastic case (4) and the second plastic case (5) are both provided with third threaded holes corresponding to the third through holes (15), and third bolts, threadedly connected to the third threaded holes, are inserted through the third through holes (15).

5. The bike saddle according to claim 4, wherein the first shell (1) and the second shell (2) are both provided with placement slots (16), the two placement slots (16) are both provided with limit posts (17), and the two limit posts (17) are integrally formed with the first shell (1) and the second shell (2), respectively.

6. The bike saddle according to claim 2, wherein the first shell (1), the second shell (2) and the first connecting block (8) are all symmetrically provided with two first reinforcing ribs (18), and the two first reinforcing ribs (18), the first shell (1), the second shell (2) and the first connecting block (8) are integrally formed.

7. The bike saddle according to claim 6, wherein both ends of each of the two first reinforcing ribs (18) are integrally formed with cylindrical sleeves (19), the two cylindrical sleeves (19) are integrally formed with the first shell (1) and the second shell (2), respectively, and the two cylindrical sleeves (19) are both provided with guide assemblies.

8. The bike saddle according to claim 7, wherein each of the guide assembly comprises a guide rod (20) installed in the cylindrical sleeve (19), and the guide rod (20) is provided with a first damping sleeve (21), wherein a top end of the first damping sleeve (21) is arranged inside the cylindrical sleeve (19), and a bottom end of the guide rod (20) is provided with a second damping sleeve (23) detachably fixed to the first damping sleeve (21).

9. The bike saddle according to claim 8, wherein two rectangular grooves (24) are symmetrically arranged on a periphery of the second damping sleeve (23), and engaging blocks (25) are arranged in the two rectangular grooves (24).
